(19) United States
(12) Patent Application Publication
(10) Pub. No.: US 2002/0095331 A1
(43) Pub. Date: Jul. 18, 2002

(54) Pay-for-results based marketing

(76) Inventors: Anas Osman, Evanston, IL (US); Azhar Usman, Skokie, IL (US)

Correspondence Address: Michael J. Pollock, STALLMAN & POLLOCK, Suite 290, 121 Spear Street, San Francisco, CA, 94105, US

(21) Appl. No.: 09/761,461

(22) Filed: Jan. 16, 2001

(51) Int. Cl. G06F 17/60

(52) U.S. Cl. 705/14; 705/1; 705/26

(57) ABSTRACT

A method of acquiring customers via a computer network includes receiving user input relating to a desired product. Then, a preferred product(s) is automatically determined from a plurality of products as a function of the user input. After the user performs an activity with a vendor, a payment is received from the vendor.

### RELATED APPLICATIONS

The following application is related by subject matter and is incorporated herein by reference:

Application Ser. No. ______ to entitled “Neural Network-Based Decision Processor and method” Attorney reference 10571/5.

### BACKGROUND OF THE INVENTION

Advertising and direct marketing have traditionally been used to acquire new customers for various products and services. Recently, Internet-based advertising and marketing have become common. Internet-based advertising typically charges a vendor a fee for each thousand users who view the advertising banner. Such fees are called cost-per-thousand (CPM) fees. If the prospective customer selects the banner advertisement, the prospective customer is commonly directed to the vendor's Internet site or is presented with additional advertisements, coupons, or information. The hosting Internet site may randomly present a variety of banners to the various users or the hosting Internet site may rotate through the banners. Typically, less than 0.2% of the users of the site hosting the banner will select the banner. The vendor may also pay the Internet site hosting the banner a periodic fee or a per-click fee.

Companies, such as ValueClick, Inc., provide a performance-based advertising on a cost-per-click (CPC) basis. Subscribers to ValueClick pay as a function of the number of times their banner advertisements are clicked on. For example, a vendor may pay the site hosting the banner $0.12 to $0.15 each time a user selects the banner.

Internet-based direct marketing allows a computer user to choose to receive marketing information for a particular vendor or for a particular subject matter. For example, a user may be asked if he wishes to receive marketing from a vendor when the computer user sign-up for an account at the vendor's Internet site. Advertisements can be directed to users from a specific country or targeted to specific markets, such as automotive, business and finance, careers, consumer technology, E-community and portals, entertainment and media, family and lifestyles, games, health and fitness, MIS and IT, news and culture, E-commerce and shopping, sports and recreation, travel, and youth and students.

Advertisements can be directed to users from a specific country or targeted to specific markets, such as automotive, business & finance, careers, consumer technology, community & portals, entertainment & media, family & lifestyles, games, health & fitness, MIS & IT, news & culture, e-commerce & shopping, sports & recreation, travel, youth & students, and more.

Traditional Internet advertisements and direct marketing are relatively costly on a per actual customer basis. A vendor may spend $400 to $700 in advertising and marketing fees for each customer the vendor actually receives as a result of traditional Internet advertisements and direct marketing. The cost of acquiring a customer via online advertising and marketing is approximately twice the cost of more traditional advertising. Vendors are estimated to have spent $182 billion on advertising and $350 billion on direct marketing in 2000. An estimated $7 billion will be spent by vendors on Internet advertising in 2000, increasing to $25 billion by 2004.

Internet-based portals and search engines, such as Lycos and Yahoo!, provide the capability to search for a product with specific features and to connect with retailers of the products. Such portals and search engines provide search services free of charge to the user and receive revenue from banner advertisements. Manufactures, such as Ford Motor Co., allow users to select products and features from the product offered by the manufacture. Internet sites, such as ActiveBuyersGuide.com's, CompareltAll.com's, and Point.com's, provide automated selection tools that guide a user to products based on user provided criteria. Vendors pay ActiveBuyersGuide.com and Point.com as a function of monthly banner advertisement and licensing fees.

### SUMMARY

By way of introduction only, a method of acquiring customers via a computer network includes receiving user input relating to a desired product. Then, a preferred product(s) is automatically determined from a plurality of products as a function of the user input. After the user performs an activity, such as opening an account, with a vendor, a payment is received from the vendor. Thus, the customer is provided with the best vendor for the customer's needs and the vendor is provided with the best customers for the vendor's products.

The foregoing discussion has been provided only by way of introduction. Nothing in this section should be taken as a limitation on the following claims, which define the scope of the invention.

### BRIEF DESCRIPTION OF SEVERAL VIEWS OF THE DRAWINGS

FIG. 1 illustrates a block diagram of a customer acquisition system;

FIG. 2 illustrates a block diagram of a customer acquisition server; and

FIG. 3 illustrates a flow diagram of a method of operation of the customer acquisition server.

### DETAILED DESCRIPTION

Results-based marketing matches potential customers with vendors using a decision engine. The decision engine may be a computer program that receives customer inputs and provides a preferred product(s) or service(s). The provider of the decision engine benefits when the potential customer becomes an actual customer. Such a system aligns the goals of the potential customer, the provider of the decision engine, and the vendor. The potential customer wishes to find the best product for the customer's need. The decision engine reduces the search costs and search time for the potential customer. Since the intelligent decision engine provider is rewarded by the vendor when the user performs an activity with the vendor, the decision engine provider has an incentive to provide customized, unbiased product information to the potential customer. The vendor pays the decision engine provider based on the user's actual performance with the vendor. The per customer cost of results-based marketing is substantially less than traditional advertising including Internet banner advertising and cost-per-click advertising. Therefore the interests of the potential customer, the vendor, and the decision engine provider are properly aligned. The customer is provided with the best vendor for the customer's needs and the vendor is provided with the best customers for the vendor's products.

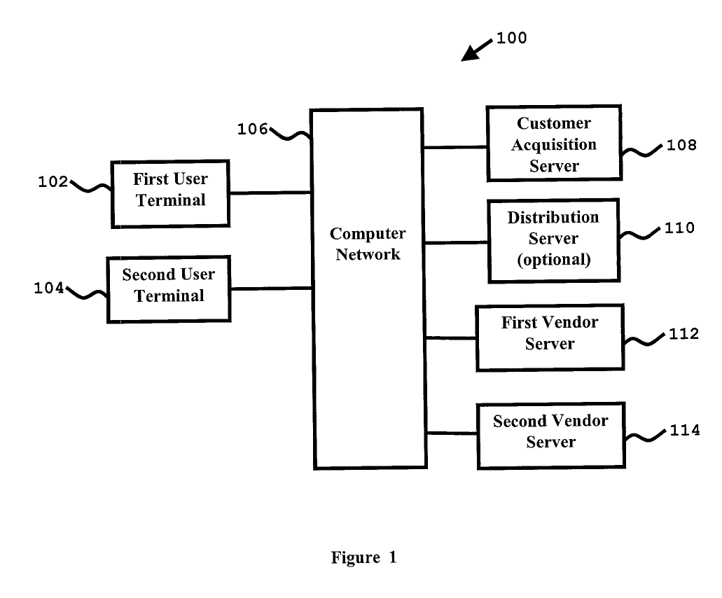

FIG. 1 illustrates a customer acquisition system 100. The customer acquisition system 100 includes a computer network 106 interconnecting user terminals 102 and 104, a customer acquisition server 108, an optional distribution server 110, and various vendor servers 112 and 114.

The customer acquisition system 100 may be accessed by a potential customer to select a product or service from a variety of products or services based on the user's specific needs. The term “product” includes physical products, financial products (financial instruments), services, and combinations thereof. The potential customer accesses the customer acquisition server 108 via the user terminal 102 over the computer network 106. The customer acquisition server 108 interactively presents a variety of questions, choices, scenarios, etc. to the customer. The subsequent questions or choices may be dependent on the potential customer's earlier answer or answers. The customer acquisition server 108 then presents the customer with one or more preferred products or services. The user may access the customer acquisition server 108 free of charge or after logging into the customer acquisition server 108.

The following example illustrates an embodiment of the customer acquisition system 100 used in a particular application. A user at the first user terminal 102 wishes to open a bank account. The user terminals 102 and 104 may be a personal computer, a workstation, a computer terminal, a cellular telephone, a personal digital assistant (PDA), a web TV terminal, or other user input device. The computer network 106 may be a computer network such as the Internet, a telephone network, a WebTV® network, a local area network, a wireless network, or other network. The user accesses the customer acquisition server 108 over the computer network 106. The customer acquisition server 108 presents various questions to the user. The questions may include such questions as:

1. What city do you live in? or Where in the city do you live?

2. What city do you work in? or Where in the city do you work?

3. Do you require a convenient bank branch near both your home and your office?

4. (If question 3 is answered in the negative then question 4 is asked) Is it more important to have a convenient bank branch near home or your office?

5. Do you use banking services other than checking and saving accounts?

6. Rank the following banking services from the most important to the least important: A. free check printing, B. drive up teller windows, C. extended lobby hours; D. on-line banking; and E. low ATM fees.

7. (The options presented in this questions are based on multiple preceding questions) Which would you prefer: A. a branch office near your home without a drive-up teller window or B. a branch office near your office that also offered on-line banking services.

8. Rank the following banks (1 being the most unfavorable and 10 being most favorable, select zero if you have no opinion)

ABC Bank_{—}

MNO Bank and Trust_{—}

XYZ Bank and loan_{—}

The user is then presented a list of banks that best suit the answers, these are called the preferred banks. For example, three banks may be presented in ranked order, such as, ABC Bank, DEF Bank, and MNO Bank. The user may be presented with the opportunity to receive detailed information about each bank by selecting a hyper-link. The user may be presented with the opportunity to open an account at the preferred banks. The user may disregard the preferred banks and choose to receive information from a different bank and optionally open an account at the non-preferred bank. Once the user performs an activity with a bank, the bank pays a fee to the owner or operator of the customer acquisition server 108.

While the above example illustrates a user receiving information about banking services via the customer acquisition system 100, numerous other products and services can also be provided. In other embodiments of the customer acquisition system 100, potential buyers are matched with vendors in the brokerage, insurance, mortgage, consumer products, utility services, telecommunications services, industrial commodities, and credit card industries.

Optionally, the customer acquisition server 108 may be hosted on a distribution server 110. The distribution server 110 may be an Internet portal, search engine, vendor site or other Internet site. The customer acquisition server 108 and the distribution server 110 may be physically different computers or may be a single computer performing both functions. The operator of the distribution server 110 may offer access to the customer acquisition server 108 to increase the services provided to distribution server's 110 users and to add an additional revenue source to the distribution server's 110 traditional revenue sources.

Revenues may be generated from the operation of the customer acquisition server 108 in a variety of manners, including banner advertising fees, periodic fee, results-based fees, and other fees and charges. Results-based fees include fees paid by a vendor as a function of the user's activities with the vendor. For example, if a user accesses the customer acquisition server 108 via the distribution server 110 and subsequently opens an account with the vendor, the vendor would then pay a fee to the operator of the customer acquisition server 108 and/or the distribution server 110.

The results-based fee may be in addition to other fees, such as banner advertising fees or licensing /listing fees. The vendor may determine that a user was referred to the vendor by the customer acquisition server 108 by one or more of a variety of methods. For example, the customer acquisition server 108 may cause a cookie to be created on the user's computer. The cookie may keep track of information about the user's Internet activities including the fact that the customer acquisition server 108 referred the user to the vendor. Such a cookie may expire, for example after 60 or 90 days. Other methods of tracking the user may also be used. For example, the user may be given a user ID to access the vendor server 112, the customer acquisition server 108 may direct the user to the vendor server 112 and send a notice to the vendor server 112 indicating the user came from the customer acquisition server 108. Such a notice need not reach the vendor server 112 substantially simultaneously with the user's access to the vendor server 112. Other methods of indicating the user was referred from the customer acquisition server 108 are also appropriate.

The vendor server 112 may host a network site, such as an Internet web site, that offers products and services over the network. The network site of the vendor may be hosted by a third party or by the vendor.

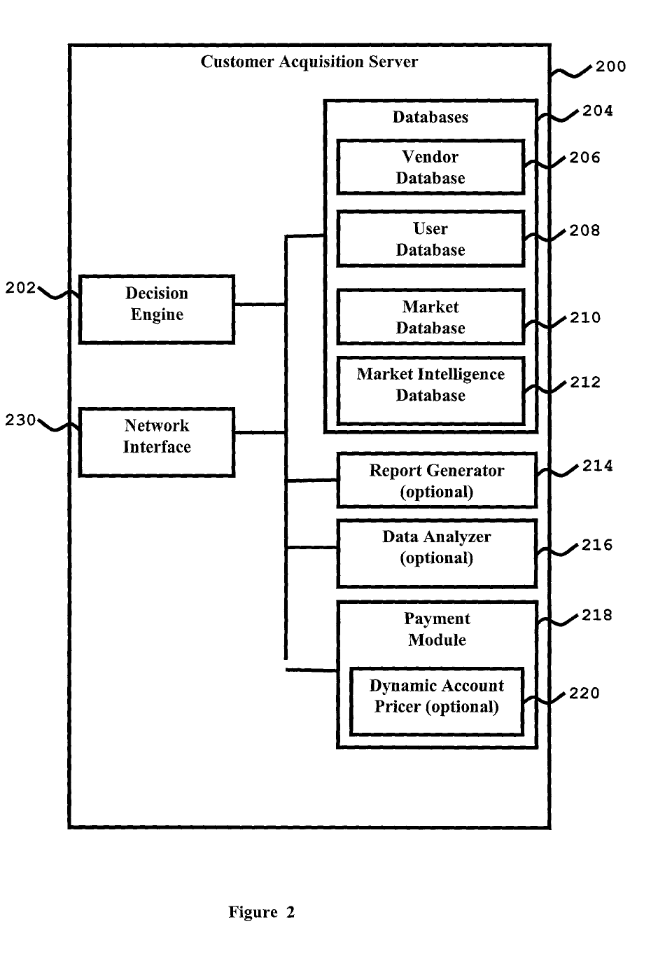

FIG. 2 illustrates a block diagram of a customer acquisition server 200, also called a Customer Acquisition Management System 200. The customer acquisition server 100 (FIG. 1) may include some or all of the features of the customer acquisition server 200. The customer acquisition server 200 may include one or more of the following: a network interface 230, a decision engine 202, a set of databases 204, a report generator 214, a data analyzer 216, and a payment module 218.

The network interface 230 connects the customer acquisition server 200 to a network, preferably a computer network 106 (FIG. 1). The network interface 230 may also connect with networks such as television networks, telephone networks, satellite networks, and other networks.

The decision engine 202 provides the user (potential customer) an interactive interface to select product or services. Decision wizards, comparative product charts, and other tools may be used in the interactive interface. The decision engine 202 also may provide information about the various product or services. The decision engine 202 may present a series of questions to the user about the features of the product or service as described above in reference to the customer acquisition server 100. Predictive networks and artificial intelligence may be used in the decision engine 202.

The databases 204 may include vendor data, market data, and buyer data. The databases 204 may be partitioned into one or more databases, such as a vendor database 206, a user database 208, a market database 210, and a market intelligence database 212. The vendor database 206 may include information about the vendor, the products that the vendor carries, vendor specific pricing and options, and the vendor's Internet site address. The vendor database 206 may also include detailed information about the products and services offered, including price, features, brand names, delivery methods (including on-line, store front, or via distributors), availability dates, and other information.

The user database 208 may include information collected about the users. For example, the user database 208 may include information about the user such as age, income level, gender, address (home and/or office), and planned purchase timeframe. After the user has used the customer acquisition server 200 to compare products or services, the user database 208 may include the user's preferences entered in the selection process and the user's down-selected list. The preferences of multiple users may be used to develop trend information that is stored in the market intelligence database 212. For example, the trend information may show that 80% of users want on-line banking, 50% of users want interest bearing checking accounts, and 2% of users want their photograph on their checks. Another example of trend information may be that 80% of users that match 100% of the search criteria open an account at a preferred vendor. After the user has purchased a product or service via the customer acquisition server 200, the user database 208 may include information about the user's prior purchases. The user database 208 may also contain other user information such as the user's purchasing preferences obtained from other sources.

The market database 210 may include information about trends in the market place. For example, the market database 210 may include information about a trend among banking customers for more on-line banking and ATM banking features and less in-bank services. The market intelligence database (MID) 212 may include syndication, distribution and licensing of buyer data, vendor data, product data, and market data collected by the customer acquisition server 200. Data mining techniques may be used on the data in the MID 212 to develop market trend data, competitive analysis, vendor profiles, and customer profiles.

The optional report generator 214 provides reports including vendor reports that indicate activities between users and vendors, user reports that indicate users activities with the customer acquisition server 200 and/or the vendors, preference reports that indicate trends in customer preferences, ad hoc reports, and others.

The optional data analyzer 216 may provide customizable data analysis tools. For example, the data analyzer 216 may provide customized or ad hoc data analysis that the distribution server 110 (FIG. 1) or the vendor server 112 can use to fine tune the marketing of the product or services.

The payment module 218 calculates the fees charged to the vendors. Such fees may include periodic fees, banner fees, and performance-based fees. The performance-based fees include fees based on the activities between users and vendors, when the users are referred to the vendor by the customer acquisition server 200. A user is referred to a vendor when the customer acquisition server 200 provides the user information about a product or service offered by the vendor or when the customer acquisition server 200 provides the user information about the vendor.

Vendors pay the banner host and the decision engine provider for such user activities. User activities may include opening a new account with the vendor, purchasing a product, or other activity. By providing incentives for the user's activity at the vendor site, the banner host is motivated to screen the user.

The payment module 218 may also calculate fees between the owner or operator of the distribution center 110 and the owner or operator of the decision server 108. Such fee may include one-time or periodic licensing fees, per transaction fees, fee sharing arrangements, and other fees. For example, the decision server 108 owner may receive a fee from the various vendors for each account opened by users of the decision server 108 and share a percentage of the fee with the distribution center 110 owner.

The payment module 218 may include an optional dynamic account pricer (DAP) 220. The DAP 220 dynamically determines a price for a user's activity at a vendor's site as a function of user's activities. For example, a bank pays a first price when a user opens an account with an opening balance of $1,000 and the bank pays a second price (higher than the first price) when a user opens an account with an opening balance of $25,000. In other examples, the DAP determines the price as a function of one or more factors including: user's income level, user's past activities, user's selection criteria, the user's profile, the number and/or types of activities the user has done during a period of time, the number of users that perform an activity with the vendor during a period of time, vendor's profile, market conditions, sales, discounts, or other criteria including combinations thereof. The fee may also be a function of a percentage of the user's transaction(s), a flat fee, or other form of fee.

Xolia's DecisionMaker, available at www.xolia.com, implements some of the features of the customer acquisition server 200. Internet-based brokerages, banks, and credit card companies and distribution portals currently use Xolia's DecisionMaker. While the above discussion of the customer acquisition server 200 focuses on financial Internet-based products and services, the customer acquisition server 200 may be used in a variety of business lines, such as credit card processing, consumer products, restaurants, travel agencies, Internet service providers, telephone service companies, insurance, telecommunications, healthcare, automotive, education, and others.

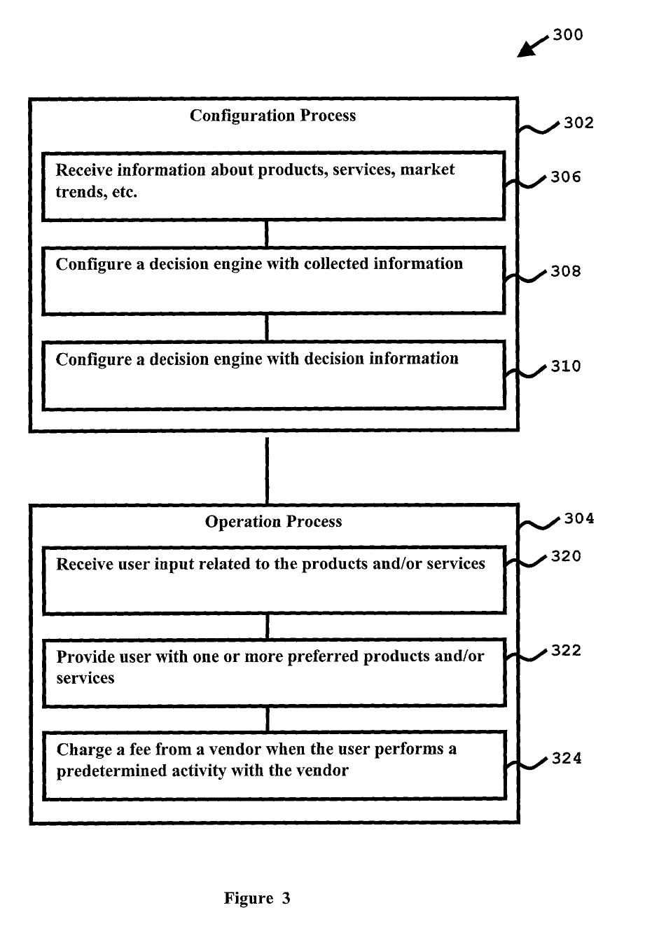

FIG. 3 illustrates a flow diagram of a method 300 of operation of the customer acquisition server 200 (FIG. 2). The customer acquisition server 200 may be configured using the configuration process 302 and is used operationally via the operation process 304. In the configuration process 302, the customer acquisition server 200 receives information 306 and configures the decision engine 308 and 310. In block 306, the customer acquisition server 200 receives information about products, services, market trends, vendors, special offers, and other information. In block 308, the customer acquisition server 200 is configured with the collected information. The customer acquisition server 200 may be configured by loading the collected information into a database(s) 204 (FIG. 2). In block 310, the customer acquisition server 200 is configured with decision information. The decision information may include correlations between features, trade-offs of various features of the products, weighting factors for user preferences or product features, and other information.

In the operation process 304, the customer acquisition server 200 receives user input 320, provides a preferred product(s) to the user 322, and receives a fee from a vendor 324. In block 320, the decision engine receives user input related to products offered be various vendors. The user input can be received via an interactive interface that intelligently asks for user input based upon the features of the products and the user's prior answers to questions. In block 322, the decision engine provides the user with one or more preferred products. The user may request more information about preferred products, the vendors offering the preferred products, related products, or other products (non-preferred products). In 324, the owner or operator of the customer acquisition server 200 receives a fee from a vendor when the user performs a predetermined activity with the vendor.

The customer acquisition server 200 (FIG. 2) and the method 300 (300) provides an improved system and method of marketing by basing the marketing fees on actual results in contrast to conventional marketing techniques that base the fees on the number of views or the number of clicks on an advertisement. The improved pay-for-results based marketing method 300 aligns the interests of the advertiser(vendor), the customer acquisition server provider, and the distribution server provider. The aligned interests eliminates many of the disadvantages of conventional systems including inaccurate counting of advertisement viewers, automated programs that generate numerous clicks on advertisements, and other schemes. Further, the improved pay-for-results method 300 allows the vendor to better determine the cost of advertising based on the vendor's desired result(s). The improved method 300 reduces the vendor's advertising expenses for ineffective advertising.

While a particular embodiment of the present invention has been shown and described, modifications may be made. It is therefore intended in the appended claims to cover all such changes and modifications which follow in the spirit and scope of the invention.

What is claimed is:

1. A method of acquiring customers via a computer network comprising:
receiving input from a user via a computer network, wherein the input relates to a plurality of products offered by one or more vendors;
automatically determining a preferred product from the plurality of products as a function of the input; and
determining a fee to be charged to a vendor as a function of an activity between the user and the vendor.

2. The method of claim 1 wherein determining a fee comprises determining a fee to be charged to a vendor as a function of a number of users that open an account with the vendor.

3. The method of claim 2 wherein determining a fee comprises determining a fee to be charged to a vendor as a function of a number of users that open an account with the vendor over a computer network.

4. The method of claim 1 wherein determining a fee comprises determining a fee to be charged to a vendor as a function of a number of users that log-in to a network site of the vendor.

5. The method of claim 1 wherein determining a fee comprises determining a fee to be charged to a vendor as a function of a number of users that access a function of a network site of the vendor.

6. The method of claim 1 wherein determining a fee comprises determining a fee to be charged to a vendor as a function of a number of users that purchase a t least one product from the vendor.

7. The method of claim 1 wherein receiving input comprises providing the user access to a decision engine via the computer network.

8. The method of claim 7 wherein providing the user access to a decision engine comprises providing the user access to vendor specific data relating to the vendors that offer the plurality of products.

9. The method of claim 8 wherein providing the user access to a decision engine comprises providing an interactive interface.

10. The method of claim 9 wherein automatically determining a preferred product comprises automatically determining a preferred product as a function of market trend data.

11. The method of claim 10 wherein automatically determining a preferred product comprises analyzing market trend data.

12. The method of claim 11 wherein automatically determining a preferred product comprises determining a prioritized list of a plurality of preferred products.

13. The method of claim 12 wherein automatically determining a preferred product comprises determining a prioritized list of a plurality of preferred products, wherein a first preferred product is offered by a first vendor and a second different preferred product is offered by a second vendor.

14. The method of claim 1 wherein charging a fee comprises charging a fixed amount for the activity between the user and the vendor.

15. The method of claim 1 wherein charging a fee comprises charging an amount for each of a plurality of activities between the user and the vendor, and wherein different amounts are received for a first activity and a second activity.

16. The method of claim 1 wherein charging a fee comprises charging an amount that is a function of the input of the user.

17. The method of claim 16 wherein charging a fee comprises charging an amount that is further a function of market data.

18. The method of claim 1 wherein automatically determining a preferred product comprises determining a preferred financial service.

19. The method of claim 18 wherein automatically determining a preferred product comprises determining a preferred banking service.

20. The method of claim 18 wherein automatically determining a preferred product comprises determining a preferred credit card service.

21. The method of claim 18 wherein automatically determining a preferred product comprises determining a preferred brokerage service.

22. A customer acquisition server, comprising:
a decision engine that determines a preferred product from a plurality of products as a function of user input received via a computer network; and
a payment module operatively connected with the decision engine, the payment module generates a bill for a vendor of a product as a function of an activity of the user at a network site of the vendor.

23. The server of claim 22 wherein the activity comprises logging into a network site of the vendor.

24. The server of claim 22 wherein the activity comprises opening an account.

25. The server of claim 22 wherein the activity comprises modifying an account.

26. The server of claim 22 wherein the activity comprises purchasing a product.

27. The server of claim 22, wherein the plurality of products comprise financial services products.

28. The server of claim 22, further comprising a network interface that links the customer acquisition server to a distribution server to allow the user to access the customer acquisition server via the distribution server.

29. The server of claim 28, wherein the distribution server further provides network portal services.

30. The server of claim 28, wherein the payment module generates a bill as a function of the input from the user.

31. The server of claim 30, wherein the payment module allocates a first portion of a receipt from the bill to a first operator of the customer acquisition server and a second portion of the receipt from the bill to a second operator of the distribution server.

32. A method of collecting preference data in a networked results-based marketing system, comprising:
providing a potential buyer access to a decision engine, wherein the decision engine receives inputs from the potential buyer relating to the potential buyer's preferences; matches the potential buyer's preferences with products; and charges the vendor a fee as a function of the potential buyer's activities at a vendor network site; and
updating the decision engine as a function of the potential buyer's preferences.

33. The method of claim 32, wherein the activities of the potential buyer include opening an account with the vendor.

34. The method of claim 33, further comprising providing at least a portion of the potential buyer's preferences to the vendors.

35. The method of claim 33 further comprising providing a summary of at least a portion of the potential buyer's preferences to the vendors.

36. The method of claim 33 further comprising providing a summary of at least a portion of the potential buyer's preferences to the vendors for a price.

37. The method of claim 36 wherein providing potential buyers access to an interactive decision engine includes providing access to a financial services related interactive decision engine.

38. A computer program product comprising a computer readable medium having computer program codes, said product comprising:
a decision engine module that selects a preferred product for a plurality of products as a function of preferences of a potential buyer received from the potential buyer via a network; and
a payment module that determines a fee for a vendor of the preferred product as a function of the potential buyer's activities with the vendor.
